(19) United States
(12) Patent Application Publication
(10) Pub. No.: US 2026/0330398 A1
(43) Pub. Date: Oct. 22, 2026

(54) SYSTEM AND METHOD FOR AUTOMATED EVALUATION AND DISPOSITION OF RETURNED ITEM

(71) Applicants: Venkates Ramalingam, McKinney, TX (US); Prabhakaran Rajendran, Cumming, GA (US); Krishnaveni Namasivayam, Cumming, GA (US)

(72) Inventors: Venkates Ramalingam, McKinney, TX (US); Prabhakaran Rajendran, Cumming, GA (US); Krishnaveni Namasivayam, Cumming, GA (US)

(73) Assignees: Venkates Ramalingam, McKinney, TX (US); Prabhakaran Rajendran, Cumming, GA (US); Krishnaveni Namasivayam, Cumming, GA (US)

(21) Appl. No.: 19/639,189

(22) Filed: Apr. 4, 2026

(51) Int. Cl. G06Q 10/0837; G06N 20/00

(52) U.S. Cl. CPC G06Q 10/0837; G06N 20/00

(57) ABSTRACT

The present disclosure relates to a system (102) and a method (300) for automated evaluation and disposition of a returned item. The system includes sensors that are configured to capture condition data of returned item at return location. The system includes data store storing reference data associated with returned item captured prior to delivery of returned item. The system includes memory and one or more processors communicatively coupled to sensors and data store. The processors are configured to compare condition data against reference data to detect physical change, contamination, damage, or tampering of returned item, and classify returned item into condition category based on comparison. The processors are configured to generate disposition determination for returned item. The system includes routing module configured to route returned item to destination selected from plurality of destination channels based on disposition determination, without requiring return of returned item to seller facility prior to routing.

### TECHNICAL FIELD

The present disclosure relates to the field of reverse logistics systems, and more particularly, to a system and a method for automated condition assessment, fraud detection, authentication, and decentralized disposition of returned items within a reverse logistics network.

### BACKGROUND

The concept of online shopping has changed the way people buy and the way they return. As e-commerce has grown, the volume of items making their way back from customers to sellers has also grown rapidly. Return rates for online purchases routinely run higher than those for goods bought in a physical store, and in categories like apparel, footwear, and consumer electronics, returns represent a meaningful share of everything sold. Cumulative cost of handling all of this, i.e., shipping items back, inspecting them, deciding what to do with them runs into the hundreds of billions of dollars.

Infrastructure built to handle these returns has not kept pace with the problem. Today, most reverse logistics systems are built around a single central idea of bringing everything back to a warehouse first, then figuring out what to do with it. A returned item travels from a customer, through a carrier facility, and all the way back to a seller's processing center before anyone looks at it closely enough to decide whether it should be restocked, discounted, donated, or thrown away.

This approach creates predictable problems. For example, items turn out to be unsalable because of being contaminated, broken, or fraudulent. Returned goods pile up at central facilities faster than they can be processed, creating backlogs that slow down inventory reintegration and leave customers waiting longer than necessary for their refunds. And when inspection does happen, it is mostly done by a person who looks at things using a process that varies from one inspector to the next and scales poorly.

Return fraud is a growing part of this problem, and it takes forms that are often surprisingly straightforward. Customers return items they have used, worn, or damaged while representing them as untouched. They send back a cheaper or broken version of what they originally bought, keeping the real item. In some cases, returned items are exposed to biological fluids or chemical substances that would make them entirely unfit for resale, yet nothing about their external appearance makes this obvious.

Existing inspection methods are not well-suited to catch most of this. Human inspectors working under visible light can see what is on the surface of an item, but biological contamination, moisture absorbed into materials, chemical residues, and internal structural damage do not always leave visible traces. This leads to fraudulent or policy-violating returns that are accepted, returned to stock, and resold, which is a problem for the seller absorbing the loss, and equally a problem for the next customer who receives something they did not expect.

Accordingly, there exists a need in the art for an improved system and method that facilitates to overcome the above-mentioned shortcomings.

### OBJECTS OF THE PRESENT DISCLOSURE

It is an object of the disclosure to provide a system and method that enables automated condition assessment of a returned item at a return location remote from a seller facility to determine condition of the returned item before any transportation decision is made.

It is still another object of the present disclosure to provide the system and method that detects contamination, biological fluids, chemical residues, and structural damage in the returned item through multi-spectral imaging to capture evidence of use, misuse, or fraud that is invisible to human eye.

It is a further object of the present disclosure to provide the system and method that applies machine learning for evaluation of returned items, enabling the system to identify patterns of fraud, contamination, and policy-violating use across large return volumes with a consistency, speed, and objectivity that manual inspection cannot match.

It is yet a further object of the present disclosure to provide the system and method that enables decentralized, condition-based disposition of the returned item directly from a return location to most appropriate destination for disposal.

It is a further object of the present disclosure to provide the system and method that accelerates issuance of customer refunds by decoupling refund authorization from physical receipt of the returned item at a seller facility to generate a real-time condition report.

### SUMMARY

Aspects of the present disclosure relate to the field of reverse logistics systems, and more particularly, to a system and a method for automated condition assessment, fraud detection, authentication, and decentralized disposition of returned items within a reverse logistics network.

An aspect of the present disclosure relates to a system and method for automated evaluation and disposition of a returned item. The system includes one or more sensors configured to capture condition data of the returned item at a return location. The return location is remote from a seller facility. The system includes a data store storing reference data associated with the returned item captured prior to delivery of the returned item, and a memory and one or more processors communicatively coupled to the one or more sensors and the data store. The one or more processors are configured to compare the condition data against the reference data to detect one or more of physical change, contamination, damage, or tampering of the returned item, and classify the returned item into a condition category based on the comparison. The one or more processors are configured to generate a disposition determination for the returned item. The system includes a routing module configured to route the returned item to a destination selected from a plurality of destination channels based on the disposition determination, without requiring return of the returned item to the seller facility prior to the routing.

In an embodiment, the condition data of the returned item comprises one or more of image data, spectral data, depth map data, weight data, or chemical sensor data associated with the returned item.

In an embodiment, the one or more processors are further configured to classify the returned item using a trained machine-learning model, where the machine-learning model is trained on the condition data associated with one or more earlier returned items.

In an embodiment, the trained machine-learning model generates a fraud probability score associated with the returned item based on detected discrepancies between the condition data and the reference data, and where the one or more processors are configured to flag the returned item for further review or rejection when the fraud probability score exceeds a configurable threshold.

In an embodiment, the routing module is configured to close an open customer order by routing the returned item directly from the return location to a recipient of the open customer order without return to the seller facility, and divert the returned item to a donation channel or a disposal facility when the condition category indicates the returned item is non-resalable.

In an embodiment, the one or more processors are further configured to generate a condition report for the returned item comprising the condition data, the reference data, the condition category, and the disposition determination, wherein the condition report is transmitted to the seller facility in real time upon completion of evaluation of the returned item at the return location.

In an embodiment, the reference data comprises a plurality of images of the returned item captured from multiple angles during outbound fulfillment, and wherein the condition data comprises a corresponding plurality of images of the returned item captured from the multiple angles at the return location.

In an embodiment, the one or more processors are further configured to authenticate an identity of the returned item by comparing a unique identifier associated with the returned item against fulfillment records stored in the data store, prior to evaluating condition of the returned item.

### BRIEF DESCRIPTION OF THE DRAWINGS

The accompanying drawings are included to provide a further understanding of the present disclosure and are incorporated in and constitute a part of this specification.

FIG. 1 illustrates an exemplary architecture of a system for automated evaluation and disposition of the returned item, in accordance with an embodiment of the present disclosure.

FIG. 2 illustrates an end-to-end operational workflow of the system, for automated evaluation, authentication, and disposition of a returned item at a robotic-enabled automatic offsite return location, in accordance with an embodiment of the present disclosure.

FIG. 3 illustrates an example flow diagram of a method 300 for the automated evaluation and disposition of a returned item, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosures as defined by the appended claims.

The present disclosure relates to a system and method for automating the evaluation, authentication, and disposition of returned items within a reverse logistics network. In prevalent times, returned items are shipped back to a seller facility before anyone decides what to do with them. The present disclosure improvises this process by moving condition assessment of the returned item to a point of return, before any transportation decision is made. At a return location, a sensor assembly captures multi-spectral condition data of the returned item to detect contamination, damage, fraud, and biological fluids that are invisible to the human eye. This condition data is compared against reference data captured when the item was originally shipped, giving the system a before-and-after picture of every returned item.

Further, a machine-learning engine analyzes this comparison, classifies the returned item, and generates a fraud probability score and disposition determination in real time. Based on this determination, the returned item is routed directly from the return location to its optimal destination.

The system also generates a real-time condition report and automatically initiates customer refunds upon acceptance to decouple refund from physical movement of the returned item. The result is a faster, smarter, and more fraud-resistant returns process that benefits sellers, customers, and the environment alike.

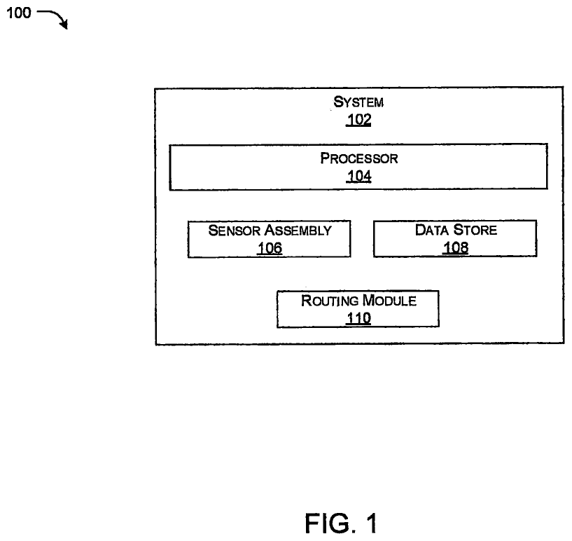

Various embodiments with respect to the present disclosure will be explained in detail with reference to FIGS. 1-3.

FIG. 1 illustrates an exemplary architecture 100 of a system 102 for automated evaluation and disposition of the returned item, in accordance with an embodiment of the present disclosure.

The present disclosure provides the system 102 for evaluating, authenticating, and routing the returned items at decentralized return locations within a reverse logistics network. The evaluation, authentication and routing is done before and independent of any transportation of the returned items back to a seller facility. By bringing condition assessment, fraud detection, and disposition decisions to a point of return, the system 102 avoids unnecessary handling, reduces costs, accelerates customer refunds, and supports better outcomes for returned items that still have usable life in them.

The reverse logistics network is not limited to any particular physical or organizational arrangement but refers broadly to a physical, digital, or operational infrastructure, through which the returned item travels from a customer back toward a seller, a redistributor, or an end-of-life channel. The reverse logistics network may include carrier-operated drop-off facilities, third-party return aggregators, locker-based return kiosks, retail return counters operating under seller authorization, and any other location at which a returned item may be received, evaluated, or redirected.

With reference to FIG. 1, the system 102 includes a sensor assembly 106. The sensor assembly 106 acts as a data acquisition layer of the system 106 and is deployed at one or more return locations remote from the seller facility. The sensor assembly 106 is responsible for capturing condition data of the returned item at the time of return. The condition data is not limited to visual or photographic information and refers to any machine-readable signal or measurement from which physical, chemical, biological, or structural state of the returned item may be assessed. Further, the Condition data includes, but is not limited to, image data captured across visible, ultraviolet, and infrared spectra, depth map data representing surface geometry, weight measurements, chemical sensor readings, spectral reflectance data, and the like.

In an embodiment, the sensor assembly 106 includes one or more sensing modalities, which may be combined in any subset depending on a context of deployment. The sensor assembly 106 comprises a visible light imaging sensor that captures standard photographic images of the returned item for surface condition assessment and comparison against reference images captured during outbound fulfillment.

The sensor assembly 106 further includes an ultraviolet (UV) imaging sensor. The UV imaging sensor illuminates the returned item with UV radiation causing biological fluids, organic contaminants, and certain chemical residues to fluoresce in a manner that is not visible under standard visible light. Using the UV radiation is particularly relevant to the detection of human liquids on surface or within material of the returned item. The human liquids may include but not limited to saliva, perspiration, blood, urine, and other bodily fluids. UV detection provides an objective, machine-readable basis for contamination decisions, thus eliminating reliance on human visual inspection

In an embodiment, the sensor assembly 106 further includes an infrared (IR) imaging sensor that is configured to detect thermal differentials, subsurface moisture accumulation, and hidden contamination that leave no visible surface indication. The IR imaging sensor detects liquid absorption into fabric, foams, or composite materials, and identifies anomalies in electronic components or packaged goods that may otherwise pass a visual inspection undetected.

In an embodiment, the sensor assembly 106 further comprises a depth imaging sensor that generates a three-dimensional surface map of the returned item. The three-dimensional surface map enables the system 102 to detect structural deformation, surface wear, denting, warping, or dimensional deviation relative to a reference profile of the returned item as originally shipped, to provide an evidence of physical use or misuse of the returned item.

Further, the sensor assembly 106 may incorporate weight sensors, chemical sensors, Radio Frequency Identification (RFID) or barcode readers, or any other sensing technology that is capable of generating the condition data.

The system 102 includes a data store 108 which is a persistent data repository that stores pre-return reference data associated with individual returned items. The reference data is captured during outbound fulfillment at the seller facility, before the returned item is shipped to the customer. The reference data is indexed to a unique item identifier such as a serial number, order number, or item-level RFID tag. In an embodiment, the reference data is not limited to images and may encompass the condition data captured from the returned item prior to customer delivery. The condition data of the returned item may be compared against the reference data to identify change, degradation, contamination, or substitution of the retuned item. In an embodiment, the data store 108 may retain images of the returned item captured from a standardized set of angles during outbound fulfillment, and the sensor assembly 106 at the return location may capture corresponding images from same angular positions to enable direct comparative analysis.

The system 102 may include one or more processors 104 (also referred to herein as processor 104) which is a core computational layer of the system 102. The processor 104 receives condition data from the sensor assembly 106, retrieves corresponding reference data from the data store 108, and performs automated comparison and analysis to generate a condition classification and disposition determination for the returned item. The disposition determination is not limited to a binary accept-or-reject outcome, and refers to any machine-generated or human-authorized output that specifies a prescribed action to be taken with respect to the returned item after evaluation. The disposition determination may specify a condition category, a recommended destination channel, a fraud probability score, a refund authorization, a hold-for-review flag, or any combination thereof.

In an embodiment, the processor 104 incorporates a machine-learning model that is trained on historical return condition data. The machine-learning model enables the processor 104 to identify patterns of wear, contamination, tampering, or substitution that are statistically associated with fraudulent or policy-violating returns. In a further embodiment, the machine-learning model generates a fraud probability score for each of the returned item. The fraud probability score may be represented as a quantified likelihood and is expressed as a scalar value within a defined range. The fraud probability score may reflect if the returned item has been subjected to use, damage, contamination, or substitution which is inconsistent with a legitimate return. When the fraud probability score exceeds a configurable threshold, the processor 104 flags the returned item for human review or generates an automatic rejection.

The fraud probability score may be expressed on a normalized scale of 0 to 1, where 0 represents no detected indication of fraudulent or policy-violating return and 1 represents highest detectable likelihood of fraud or policy violation. A fraud probability score below 0.3 may result in an automatic acceptance of the returned item. A fraud probability score between 0.3 and 0.7 may trigger escalation to a logistics agent or seller for human review. A fraud probability score exceeding 0.7 may result in automatic rejection of the returned item or diversion to a hold queue pending seller authorization.

In an embodiment, a decision engine governs a decision authority under which the disposition determination is finalized. In a first case, the system 102 may use the machine-learning model without human intervention for the disposition determination. This configuration is well suited to high-volume, low-value return flows of the return items where speed and cost efficiency are primary considerations. In a second case, the decision authority is assigned to a logistics agent that operates under seller authorization. The logistics agent reviews system-generated recommendations and takes decision within parameters that are pre-authorized by the seller. This case helps preserve human oversight for high-value returned items while using automated assessment as a decision support tool rather than a final arbiter. In a third case, the decision authority is retained by the seller directly. The seller receives real-time condition data along with system recommendations to determine final control over acceptance and routing for the returned items which the seller designates for increased scrutiny. The decision engine uses a configurable decision authority model and allows the sellers to maintain a balance between automation and control on a per-product, per-category, or per-risk-tier basis.

The system 102 includes a routing module 110 which executes the disposition determination by directing the returned item from the return location to an optimal destination channel. The execution of the disposition determination is done without requiring transportation of the returned item to the seller facility as an intermediate step. In an embodiment, the destination channel available to the routing module 110 may include a seller warehouse or fulfillment center, a third-party logistics facility, a reseller, an open customer order recipient, a donation channel, a disposal facility, and the like.

In an embodiment, when the system 102 identifies a pending customer order for an identical returned item, the routing module 110 directs the returned item from the return location directly to recipient of that open customer order. This is done while bypassing the seller facility entirely, thus reducing both fulfillment time and transportation cost in a single step.

In an embodiment, when the condition category assigned to the returned item is non-resalable, the routing module 110 diverts the returned item to a donation channel or disposal facility. The diversion is done to avoid the return item travel unnecessarily through a full reverse logistics network. The routing module 110 interfaces with carrier systems, logistics management platforms, and order management systems to generate shipping labels, manifests, and chain-of-custody records at a point of return.

In an embodiment, prior to condition evaluation, the system 102 performs an item-level authentication to verify that the returned item presented at the return location corresponds to the item that was originally shipped to the customer. The authentication module compares a unique identifier associated with the returned item against fulfillment records stored in the data store 108. The unique identifier may be such as a serial number, barcode, RFID tag, or machine-vision-derived fingerprint. A mismatch between the returned item and the fulfillment record is treated as an indicator of item substitution, a recognized vector for return fraud, and may trigger an automatic rejection determination or escalation to the decision engine.

Upon completion of evaluation, the system 102 generates a condition report for the returned item. The condition report includes a return-time condition data, a reference data, the assigned condition category, the fraud probability score where applicable, and the disposition determination. The condition report is transmitted to the seller in real time to create an auditable record of the evaluation that exists independently of the subsequent physical handling of the returned item.

In an embodiment, for returned items for which an acceptance determination has been generated, the system 102 automatically initiates a customer refund without waiting for the returned item to be physically received at the seller facility. This decoupling of refund issuance from physical receipt accelerates a refund experience of the customer and removes a source of friction that is a consistent pain point in existing returns processes.

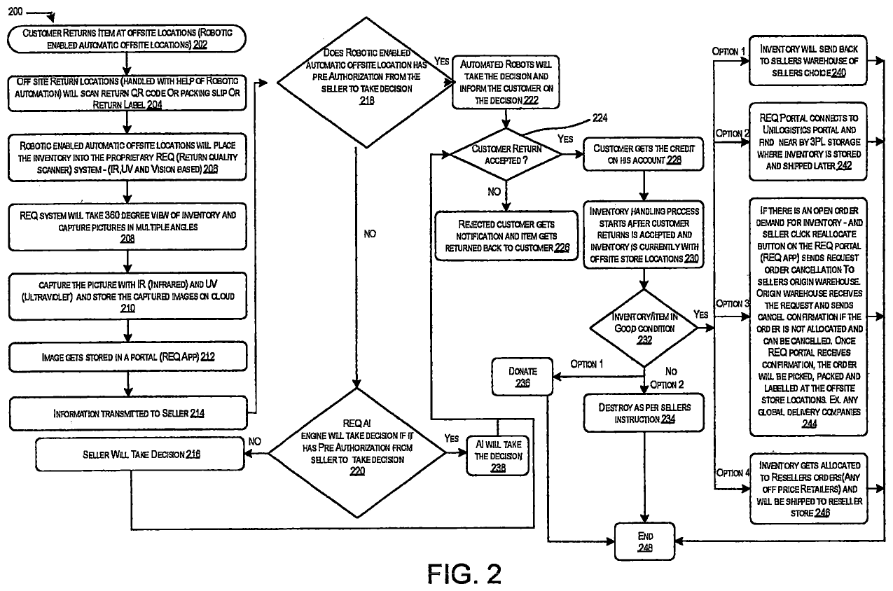

FIG. 2 illustrates an end-to-end operational workflow 200 of the system 102, for automated evaluation, authentication, and disposition of a returned item at a robotic-enabled automatic offsite return location, in accordance with an embodiment of the present disclosure.

With reference to FIG. 2, the end-to-end operational workflow 200 is initiated when a customer returns an item at a robotic-enabled automatic offsite return location at 202. The offsite return location is a return location that is remote from the seller facility and is operated with an assistance of robotic automation and constitutes a node within the reverse logistics network at which the condition data of the returned item is captured and evaluated prior to any transportation decision.

At the return location, the offsite return location scans a return QR code, packing slip, or return label associated with the returned item at 204 to enable the system 102 to retrieve fulfillment records and the reference data associated with the returned item from the data store 108. The returned item is then placed into a proprietary Return Quality Scanner (REQ) system at 206 having the IR, UV, and vision-based sensors that are part of the sensor assembly 106. The REQ system captures a 360-degree view of the returned item from multiple angles at 208, in which the reference data includes images captured from multiple angles during outbound fulfillment and the condition data includes corresponding images captured from the same angles at the return location. The sensor assembly further captures IR and UV images of the returned item, at 210 to enable detection of the biological fluids, the chemical contamination, the subsurface moisture, and the structural damage which is not detectable through the visible light imaging alone. The captured condition data is stored in the REQ system in a portal designated as a REQ app (having an REQ AI engine), at 212 and transmitted to the seller, at 214 and constitutes real-time transmission of the condition report to the seller.

Upon receipt of the condition data, the system 102 determines whether the robotic-enabled automatic offsite return location has been granted pre-authorization by the seller to take the disposition determination autonomously, at 218. In case a pre-authorization has not been granted, a decision authority is retained by the seller, who reviews the transmitted condition data and takes the disposition determination directly, at 216. When the pre-authorization has been granted, the REQ AI engine takes the disposition determination autonomously, at step 220 and informs the customer of the outcome, at 222.

Following the disposition determination, the workflow 200 presents a binary customer return acceptance outcome. In case the customer return is accepted, at 224, the customer receives credit to their account, at 228. However, if the customer return is rejected, the customer receives notification and the returned item is directed back to the customer, at 226.

When the customer return is accepted, an inventory handling process is initiated for the returned item, which remains at the offsite return location, at 230. The system 102 then evaluates whether the returned item is in a condition suitable for resale, at 232. This evaluation is based on the condition data captured by the sensor assembly 106 and the disposition determination generated by the processor 104.

When the returned item is determined to be in a resalable condition, the routing module 110 directs the returned item to one of four destination channels from the offsite return location, without requiring return of the returned item to the seller facility prior to routing. In a first embodiment, option 1, at 240, the returned item is routed to the seller's warehouse of choice for reintegration into seller inventory. In a second embodiment, option 2, at 242, the routing module 110 connects to a third-party unilogistics portal to identify nearby third-party storage facilities from which the returned item is stored and subsequently shipped. In a third embodiment, option 3, at 244, where an open customer order exists for an identical returned item, the seller may reallocate the returned item through the REQ app to fulfil the open order directly from the offsite return location, with the order being picked, packed, and labelled at the return location for dispatch by a global delivery carrier. In a fourth embodiment, option 4, at 246, the returned item is allocated to a reseller, including off-price retailers, and shipped directly to the reseller store from the return location. Another way is posting in multiple auction sites where resellers can bid and if they win the bid item will get shipped to them directly. Connection with multiple auction sites can be handled through Unilogistiqx portal.

When the returned item is determined to be non-resalable, the routing module 110 evaluates two further disposition options. In a first option, at 236, the returned item is directed to a donation channel for donation. In a second option, at 234, the returned item is directed to disposal in accordance with instructions from the seller. In both cases, the disposition is executed directly from the offsite return location without requiring transportation of the returned item to the seller facility as an intermediate step.

The workflow 200 concludes at step 248 and represents completion of the disposition process for the returned item at the offsite return location. On conclusion of the workflow 200, the returned item is routed to its optimal destination channel based on the disposition determination generated by the system 102.

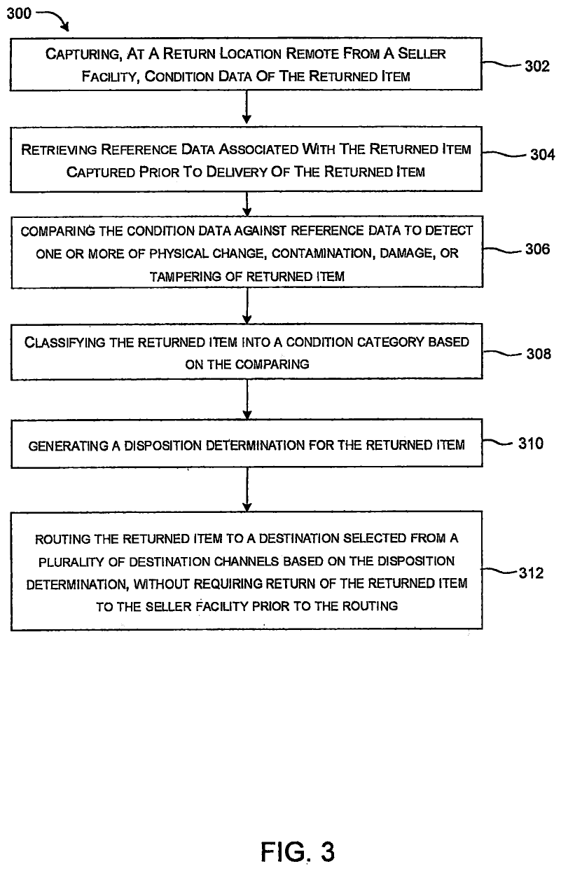

FIG. 3 illustrates an example flow diagram of a method 300 for the automated evaluation and disposition of a returned item, in accordance with an embodiment of the present disclosure.

Referring to FIG. 3, the method 300, at step 302, uses one or more sensors at the return location to capture condition data of the returned item. The method 300, at step 304 retrieves, from a data store 108, the reference data that is associated with the returned item captured prior to delivery of the returned item. Further, at step 306, the method uses one or more processors to compare the condition data against the reference data to detect one or more of physical change, contamination, damage, or tampering of the returned item, and classify, at step 308, the returned item into a condition category based on the comparing. The method 300, at step 310, generates the disposition determination for the returned item, and at step 312 route the returned item to the destination selected from the plurality of destination channels based on the disposition determination. This is done without requiring the return of the returned item to the seller facility prior to the routing.

### Advantages and Improvements Over the Existing Methods, Devices or Materials

The disclosed system 102 provides significant advantages and improvements over available solutions present in a reverse logistics industry. Managing returned items which includes transportation, inspection, processing, restocking, and fraud losses has become one of a biggest operational challenge for online sellers today. By enabling condition assessment and disposition decisions at the point of return, before an item enters a reverse transportation network, the system 102 allows sellers to stop non-resalable, contaminated, or fraudulent returns early. This avoids unnecessary shipping, handling, and disposal costs that would otherwise occur if every returned item were sent back to a seller facility first. Multi-spectral analysis capability of the system 102 makes it possible to detect biological fluid contamination, item substitution, and missing components that traditional visual inspection methods often fail to identify and help reduce exposure to return fraud without increasing reliance on manual inspection.

For legitimate returns, the system 102 improves customer experience by enabling refunds to be initiated in real time at a point of return, without waiting for the item to physically reach a facility. This faster refund process supports customer retention, especially in markets where speed matters. Items that are still in resalable condition may be routed directly from the return point to a most suitable destination, such as a seller warehouse, reseller, third-party logistics facility, or even directly to another customer order. This helps to reduce both delivery time and transportation costs.

At the same time, non-resalable items may be redirected immediately for donation or disposal at a point of return, supporting circular economy goals and reducing an environmental impact of unnecessary shipping.

In an exemplary embodiment, the system 102 illustrates operation of the system 102 of the present disclosure for the returned apparel item that has been worn and subjected to biological fluid contamination prior to return. The contamination is not visible to human eye under standard visible light conditions. For example, a customer purchases a white dress shirt through an online retail platform and initiates a return a few days after delivery, citing fit as a reason. The customer presents the returned item at a carrier-operated offsite return location equipped with the sensor assembly of the present disclosure. The returned item appears visually clean and unworn. The location scans the return label, and the system retrieves fulfillment records and reference data from the data store, including reference images from standardized angular positions, the reference weight, and the reference depth map of the shirt as originally packaged and shipped.

The returned item is placed into the REQ. The sensor assembly 106 captures condition images from the same standardized angular positions used during outbound fulfillment. Under visible light, no surface staining, discoloration, or damage is detected and the shirt appears unworn. The ultraviolet imaging sensor is then activated, and under UV illumination, collar and underarm regions exhibit fluorescence signatures consistent with perspiration and saliva. The infrared imaging sensor detects residual moisture absorption in collar lining consistent with repeated wear. The weight sensor records a value within the acceptable deviation threshold, and the depth imaging sensor confirms no structural or dimensional deviation. The processor 104 retrieves the reference data and compares it with return-time condition data.

The visible light comparison shows no discrepancy. However, the UV comparison identifies fluorescence in the collar and underarm regions absent in the reference UV images, thus confirming contamination occurred after fulfillment. The infrared comparison confirms moisture absorption not present in the reference data. The machine-learning model assigns a condition category of contaminated and generates a fraud probability score exceeding the rejection threshold. The system 102 determines rejection and compiles a condition report, which is transmitted to the seller in real time.

The seller has pre-authorized the offsite return location to take the disposition determination when the fraud probability score exceeds the threshold. Decision authority is assigned to the REQ AI engine, which issues rejection without seller intervention. The system 102 notifies the customer that the return is rejected based on condition assessment, and the item will be returned with no refund.

As the determination is rejection, the returned item does not enter inventory handling. The routing module 110 classifies the returned item as non-resalable and directs it back to the customer. The entire evaluation, classification, and determination is completed within seconds, without the item traveling to the seller facility.

Without using the disclosed system 102, the item may have been accepted based on visual appearance, shipped back at the seller's cost, and either restocked or later rejected after processing. The disclosed system 102 intercepts the returned item at the moment of return with a level of certainty that manual inspection cannot reliably replicate.

While the foregoing describes various embodiments of the disclosure, other and further embodiments of the invention may be devised without departing from the basic scope thereof. The scope of the disclosure is determined by the claims that follow. The disclosure is not limited to the described embodiments, versions, or examples, which are included to enable a person having ordinary skill in the art to make and use the disclosure when combined with information and knowledge available to the person having ordinary skill in the art.

### Advantages of the Present Disclosure

The present disclosure enables a material reduction in reverse logistics costs by allowing condition assessment and disposition decisions to be made at a return location before a returned item enters a transportation network, thus eliminating freight and handling costs associated with transporting rejected or non-resalable returned items unnecessarily to a seller facility.

The present disclosure enables stronger return fraud prevention by replacing subjective human visual inspection with objective multi-spectral analysis capable of detecting biological fluids, chemical contamination, subsurface moisture, and structural damage that are invisible under visible light at point of return.

The present disclosure enables accelerated customer refunds by allowing acceptance determinations and refund authorizations to be generated in real time at the return location, independent of physical movement of the returned item to a seller facility.

The present disclosure enables improved fulfilment efficiency by allowing returned items in resalable condition to be routed directly from the return location to an optimal destination, including fulfilment of an open customer order, without requiring return of the returned item to a seller facility.

The present disclosure enables improved circular economy outcomes by ensuring returned items are directed to their highest-value use at the point of return, whether resale, donation, or disposal, without unnecessary transportation through the full reverse logistics network.

We claim:

1. A system for automated evaluation and disposition of a returned item, the system comprising:
one or more sensors configured to capture condition data of the returned item at a return location, the return location being remote from a seller facility;
a data store storing reference data associated with the returned item captured prior to delivery of the returned item;
a memory and one or more processors communicatively coupled to the one or more sensors and the data store, the one or more processors configured to:
compare the condition data against the reference data to detect one or more of physical change, contamination, damage, or tampering of the returned item;
classify the returned item into a condition category based on the comparison; and
generate a disposition determination for the returned item; and
a routing module configured to route the returned item to a destination selected from a plurality of destination channels based on the disposition determination, without requiring return of the returned item to the seller facility prior to the routing.

2. The system as claimed in claim 1, wherein the condition data of the returned item comprises one or more of image data, spectral data, depth map data, weight data, or chemical sensor data associated with the returned item.

3. The system as claimed in claim 1, wherein the one or more processors are further configured to classify the returned item using a trained machine-learning model, where the machine-learning model is trained on the condition data associated with one or more earlier returned items.

4. The system as claimed in claim 3, wherein the trained machine-learning model generates a fraud probability score associated with the returned item based on detected discrepancies between the condition data and the reference data, and where the one or more processors are configured to flag the returned item for further review or rejection when the fraud probability score exceeds a configurable threshold.

5. The system as claimed in claim 1, wherein the routing module is configured to:
close an open customer order by routing the returned item directly from the return location to a recipient of the open customer order without return to the seller facility, and
divert the returned item to a donation channel or a disposal facility when the condition category indicates the returned item is non-resalable.

6. The system as claimed in claim 1, wherein the one or more processors are further configured to generate a condition report for the returned item comprising the condition data, the reference data, the condition category, and the disposition determination, wherein the condition report is transmitted to the seller facility in real time upon completion of evaluation of the returned item at the return location.

7. The system as claimed in claim 1, wherein the reference data comprises a plurality of images of the returned item captured from multiple angles during outbound fulfillment, and wherein the condition data comprises a corresponding plurality of images of the returned item captured from the multiple angles at the return location.

8. The system as claimed in claim 1, wherein the one or more processors are further configured to authenticate an identity of the returned item by comparing a unique identifier associated with the returned item against fulfillment records stored in the data store, prior to evaluating condition of the returned item.

9. A method for automated evaluation and disposition of a returned item, the method comprising:
capturing, by one or more sensors at a return location remote from a seller facility, condition data of the returned item;
retrieving, from a data store, reference data associated with the returned item captured prior to delivery of the returned item;
comparing, by one or more processors, the condition data against the reference data to detect one or more of physical change, contamination, damage, or tampering of the returned item;
classifying, by the one or more processors, the returned item into a condition category based on the comparing; and
generating, by the one or more processors, a disposition determination for the returned item; and
routing the returned item to a destination selected from a plurality of destination channels based on the disposition determination, without requiring return of the returned item to the seller facility prior to the routing.

10. The method as claimed in claim 9, wherein the condition data of the returned item comprises one or more of image data, spectral data, depth map data, weight data, or chemical sensor data associated with the returned item.

11. The method as claimed in claim 9, wherein the classifying comprises applying a trained machine-learning model to the condition data, wherein the machine-learning model is trained on condition data associated with one or more earlier returned items.

12. The method as claimed in claim 11, further comprising:
generating, by the trained machine-learning model, a fraud probability score associated with the returned item based on detected discrepancies between the condition data and the reference data; and
flagging the returned item for further review or rejection when the fraud probability score exceeds a configurable threshold.

13. The method as claimed in claim 9, wherein the routing comprises one or more of:
closing an open customer order by routing the returned item directly from the return location to a recipient of the open customer order without return of the returned item to the seller facility; and
diverting the returned item to a donation channel or a disposal facility when the condition category indicates the returned item is non-resalable.

14. The method as claimed in claim 9, further comprising:
generating a condition report for the returned item comprising the condition data, the reference data, the condition category, and the disposition determination; and
transmitting the condition report to the seller facility in real time upon completion of evaluation of the returned item at the return location.

15. The method as claimed in claim 9, wherein the reference data comprises a plurality of images of the returned item captured from multiple angles during outbound fulfillment, and wherein the condition data comprises a corresponding plurality of images of the returned item captured from the multiple angles at the return location.

16. The method as claimed in claim 9, further comprising authenticating an identity of the returned item by comparing a unique identifier associated with the returned item against fulfillment records stored in the data store, prior to the comparing of the condition data against the reference data.

17. A non-transitory computer-readable medium comprising processor-executable instructions that, when executed by one or more processors, cause the one or more processors to
capturing, by one or more sensors at a return location remote from a seller facility, condition data of the returned item;
retrieving, from a data store, reference data associated with the returned item captured prior to delivery of the returned item;
comparing, by one or more processors, the condition data against the reference data to detect one or more of physical change, contamination, damage, or tampering of the returned item;
classifying, by the one or more processors, the returned item into a condition category based on the comparing; and
generating, by the one or more processors, a disposition determination for the returned item; and
routing the returned item to a destination selected from a plurality of destination channels based on the disposition determination, without requiring return of the returned item to the seller facility prior to the routing.
